(19) United States
(12) Patent Application Publication
(10) Pub. No.: US 2026/0239253 A1
(43) Pub. Date: Aug. 13, 2026

(54) SENSOR DATA COLLECTION METHOD AND SENSOR DEVICE

(71) Applicant: NTT, Inc., Tokyo (JP)

(72) Inventors: Akio Tokura, Tokyo (JP); Kenichi Matsunaga, Tokyo (JP); Kazuhiko Takagahara, Tokyo (JP)

(21) Appl. No.: 19/154,185

(22) PCT Filed: Feb. 7, 2023
(86) PCT No.: PCT/JP2023/003921

§ 371 Date: Aug. 6, 2025

(51) Int. Cl. H04W 56/00; H04W 4/38

(52) U.S. Cl. CPC H04W 56/005; H04W 4/38

(57) ABSTRACT

An embodiment is a sensor data collection method for a sensor device including a wireless communication circuit, a memory, a clock circuit and a buffer. The method includes determining whether or not the sensor device is connected to a receiver by referring to session information managed by the wireless communication circuit. When the sensor device is connected to the receiver, the method wirelessly transmits data to the receiver without storing the data in the memory. When communication with the receiver is disconnected on the basis of the session information and the disconnection is not caused by reception of a disconnect packet from the receiver, the method receives data from the buffer in a format for transmitting to the receiver and stores the data in the memory in a specific order for each predetermined data unit.

### CROSS-REFERENCE TO RELATED APPLICATIONS

This application is a national phase entry of PCT Application No. PCT/JP2023/003921, filed on Feb. 7, 2023, which application is hereby incorporated herein by reference.

### TECHNICAL FIELD

The present invention relates to a sensor data collection method and a sensor device that wirelessly transmit sensor data.

### BACKGROUND

In an Internet of Things (IoT) society in which all things are connected to the Internet, various kinds of sensors are connected to a network, and it is expected to extract information useful for humans by collecting a large variety and amount of data and analyzing the data. When sensor data acquired by a sensor is collected, wireless data transfer is generally required to improve a degree of freedom of installation, and in particular, in a case where biometric data is collected, wireless communication contributes to improvement in convenience (Non Patent Literature 1).

Wireless transmission of sensor data is effective in improving the convenience, but unexpected data loss may occur, for example, when a wireless environment suddenly deteriorates. As a technique for preventing such data loss, there are known, for example, a method of storing all data in a sensor (Non Patent Literature 2) and a method by delivery confirmation (Chapter 3.8 of Non Patent Literature 3).

However, the method of storing all data in a sensor device requires a large-capacity memory in order to store a large amount of data, and thus problems such as increase in cost and increase in size of the sensor device are likely to occur. Meanwhile, wireless real-time transmission and data backup by the sensor device are performed in parallel in some cases. However, in this case, data duplication occurs, and the convenience of data processing and analysis deteriorates. In the method by delivery confirmation, stability of transmission/reception increases, but there is a problem that a communication speed is adversely affected by overhead caused by delivery confirmation.

### CITATION LIST

### Non Patent Literature

Non Patent Literature 1: Nahoko Kasai, Takayuki Ogasawara, Hiroshi Nakashima, and Shingo Tsukada, “Development of Functional Textile “hitoe”: Wearable Electrodes for Monitoring Human Vital Signals”, The Institute of Electronics, Information and Communication Engineers, Communication Society Magazine, Vol. 11, No. 1, pp. 17-23, Jun. 1, 2017, Online ISSN 2186-0661, <https://doi.org/10.1587/bplus.11.17>
Non Patent Literature 2: “Holter recorder eMEMO WR-100”, Medical device package insert, Fukuda Denshi Co., Ltd., November 2020, <https://www.pmda.go.jp/PmdaSearch/kikiDetail/ResultDataSetPDF/670053_228ADBZX00113000_A_02_01>
Non Patent Literature 3: RFC9293 Transmission Control Protocol (TCP), Internet Engineering Task Force (IETF), August 2022, <https://www.rfc-editor.org/rfc/rfc9293.html>

### SUMMARY

The present invention has been made to solve the above problems, and an object thereof is to provide a sensor data collection method and a sensor device capable of significantly reducing loss of sensor data and implementing low-cost and stable automatic data collection.

### Solution to Problem

A sensor data collection method according to the present invention includes: a first step in which a sensor device refers to session information managed by a wireless communication unit of the sensor device to determine whether or not the sensor device is connected to a receiver; a second step in which, when determining that the sensor device is connected to the receiver, the sensor device stops storing data to be transmitted to the receiver in a memory of the sensor device and wirelessly transmits the data to the receiver; a third step in which, when determining that communication with the receiver is disconnected on the basis of the session information and also determining that the disconnection is not caused by reception of a disconnect packet from the receiver, the sensor device stores the data in the memory; and a fourth step in which the sensor device stores time information acquired from a clock unit of the sensor device in the memory in association with the data stored in the memory, in which the third step includes a step of receiving data of a same format as the data to be transmitted to the receiver from a buffer of the sensor device and storing the data in the memory in a specific order for each predetermined data unit.

A sensor device according to the present invention includes: a wireless communication unit configured to perform communication with a receiver; a memory for storing data to be transmitted to the receiver; a clock unit configured to measure time; and an MPU that, when determining that the sensor device is connected to the receiver on the basis of session information managed by the wireless communication unit, stops storing the data to be transmitted to the receiver in the memory and wirelessly transmits the data to the receiver via the wireless communication unit in real time, and, when determining that communication with the receiver is disconnected on the basis of the session information and also determining that the disconnection is not caused by reception of a disconnect packet from the receiver, stores the data in the memory and stores time information acquired from the clock unit in the memory in association with the data, in which the MPU receives data of a same format as the data to be transmitted to the receiver from a buffer and stores the data in the memory in a specific order for each predetermined data unit.

### Advantageous Effects of Invention

According to the present invention, it is possible to automatically switch operation of a sensor device between a real-time data transmission operation and a memory storage operation only for data that cannot be wirelessly transmitted by condition determination based on session information regarding a wireless communication state. The present invention can reduce the possibility that data loss occurs when data transmission becomes impossible due to, for example, deterioration of a radio wave condition. Further, because the real-time transmission and the data backup by the sensor device are not performed in parallel, it is possible to reduce the possibility of data duplication. The present invention makes it easy to combine data, thereby improving the convenience of data utilization. The present invention does not need to store all sensor data in a memory and thus does not require a large-capacity memory unlike the related art. This makes it possible to reduce the cost of the sensor device. Further, the present invention does not use the method by delivery confirmation in the related art, and thus a communication speed is not reduced due to the delivery confirmation.

### BRIEF DESCRIPTION OF THE DRAWINGS

FIG. 1 is a block diagram showing a configuration of a sensor data collection system according to a first embodiment of the present invention.

FIG. 2 is a block diagram showing a configuration example of a sensor front end of a sensor device according to the first embodiment of the present invention.

FIGS. 3A and 3B show operations of a conventional sensor device.

FIGS. 4A and 4B show operations of the sensor device according to the first embodiment of the present invention.

FIG. 5 shows a method of storing data in a memory of the sensor device according to the first embodiment of the present invention.

FIG. 6 is a flowchart showing an operation of the sensor device according to the first embodiment of the present invention.

FIG. 7 is a flowchart showing an operation of the sensor device according to the first embodiment of the present invention.

FIG. 8 is a flowchart showing an operation of the sensor device according to the first embodiment of the present invention.

FIG. 9 is a flowchart showing an operation of a receiver according to the first embodiment of the present invention.

FIG. 10 is a flowchart showing an operation of the receiver according to the first embodiment of the present invention.

FIG. 11 shows an operation of a data combining unit according to the first embodiment of the present invention.

FIG. 12 shows an operation of a sensor device according to a second embodiment of the present invention.

FIG. 13 is a flowchart showing an operation of the sensor device according to the second embodiment of the present invention.

FIG. 14 is a block diagram showing a configuration of a sensor data collection system according to a third embodiment of the present invention.

FIG. 15 is a flowchart showing an operation of a sensor device according to the third embodiment of the present invention.

FIG. 16 is a flowchart showing an operation of a receiver according to the third embodiment of the present invention.

FIG. 17 is a block diagram showing a configuration of a sensor data collection system according to a fourth embodiment of the present invention.

FIG. 18 is a flowchart showing an operation of a sensor device according to the fourth embodiment of the present invention.

FIG. 19 is a flowchart showing an operation of the sensor device according to the fourth embodiment of the present invention.

FIG. 20 is a flowchart showing an operation of a receiver according to the fourth embodiment of the present invention.

FIG. 21 is a flowchart showing an operation of the receiver according to the fourth embodiment of the present invention.

FIG. 22 is a flowchart showing an operation of a sensor device according to a fifth embodiment of the present invention.

FIG. 23 is a block diagram showing a configuration example of a computer that implements the sensor data collection systems according to the first to fifth embodiments of the present invention.

### DETAILED DESCRIPTION OF ILLUSTRATIVE EMBODIMENTS

### Principle of Invention

In a wireless sensor device that wirelessly transmits sensor data in real time, data loss occurring due to communication interruption caused by deterioration of a wireless situation or a distance from a receiver being out of a communication range cannot be prevented only by improvement in radio wave transmission/reception performance.

In order to fundamentally solve the problem of data loss, it is necessary to store data that cannot be transmitted in the sensor device and read the data later. As described above, in a case where data is constantly backed up in a memory, a large memory capacity is required. Further, data transmitted to the receiver and data stored in the memory are independent of each other, and thus data duplication occurs. This causes inconvenience in data utilization.

In order to efficiently store data in the memory without reducing the convenience, it is necessary to switch operation from wireless data transmission to data storage in an internal memory at a timing at which data transmission becomes impossible. However, because communication with the receiver is interrupted, it is impossible to adopt a method of switching the operation by transmitting a command from the receiver.

Wireless communication standards for a sensor, such as Bluetooth (registered trademark) low energy (BLE), define session information for confirming whether or not communication is continuously established (connected). In other words, the presence of the session information indicates that wireless communication can be smoothly performed, and the absence of the session information indicates that wireless communication is disconnected. Therefore, it is possible to reduce the probability of occurrence of data loss by incorporating the session information into determination of the operation to separate communication maintenance and communication interruption, storing data to be transmitted in the memory of the sensor device only at the time of communication interruption, and reading the sensor data later.

However, the session information is generally binary information indicating whether or not communication is being continued. Therefore, it is impossible to distinguish between a situation in which a user of the sensor data collection system intentionally completes/disconnects communication and a situation in which communication disconnection not intended by the user occurs due to, for example, deterioration in a wireless environment on the basis of the session information. Accordingly, in some cases, data is stored in the memory of the sensor device even after the user intentionally disconnects communication. In a case where data is continuously stored in the memory of the sensor device, the memory may become insufficient, and the operation of the sensor device may fail.

Therefore, the present invention can obtain ternary information for determination by including case classification based on the cause of change (cancellation) of the session information and distinguish between the situation in which the user intentionally completes/disconnects communication and the situation in which communication disconnection not intended by the user occurs. Specifically, the present invention uses the fact that, in a case where the user intentionally completes/disconnects communication (measurement), a disconnect packet for disconnect processing is normally transmitted to the sensor device.

It is possible to clearly identify cancellation of the session information caused by the a disconnect packet for the disconnect processing and cancellation of the session information caused by reasons other than the disconnect processing. Therefore, only disconnection caused by the disconnect processing is set as a condition for determining the normal end of the measurement. Most of the cancellation of the session information caused by reasons other than the disconnect processing is caused by connection confirmation timeout (supervision timeout). A cancellation state of the session information caused by reasons other than the disconnect processing is determined as disconnection not intended by the user, and operation is switched to storing data in the memory.

By adopting the operation determination using the ternary information in the sensor device, it is possible to implement a function of automatically switching between real-time transmission of the sensor data, memory storage, and the end of the measurement.

Strictly speaking, data loss for an internal determination time until the supervision timeout occurs may occur. However, it is sufficiently possible to suppress a data loss time to such an extent that there is no practical problem by, for example, appropriately adjusting a value of the supervision timeout or buffering data in the internal memory for several seconds in consideration of a determination time of the supervision timeout.

It is also necessary to devise a way to switch between the real-time transmission of the sensor data and the memory storage. In a case where the real-time transmission is performed, acquired sensor data (primary data) and data (secondary data) processed by an MPU of the sensor device may be collectively transmitted. When transmission of the primary data and the secondary data to a wireless communication unit of the sensor device or transmission thereof to the internal memory are instantaneously switched, a delay occurs in the processing, and operation is not appropriately performed in some cases.

The load increases when the memory is sequentially accessed, and thus it is more efficient to accumulate a certain amount of data and collectively store the data in the memory at regular intervals. Therefore, a certain amount of data to be stored in the memory is temporarily stored in a buffer area of the MPU of the sensor device. This makes it possible to quickly switch to the memory storage operation in a case where the session information is canceled.

Because the real-time transmission and the memory storage are switched in a method of the present invention, the real-time data and the memory-stored data are not duplicated. This eliminates the necessity of concerning duplication when the real-time data and the memory-stored data are combined, but if the real-time data and the memory-stored data have different formats, the user cannot process the real-time data and the memory-stored data as continuous data, which is inconvenient. In order to continuously handle data, it is necessary to unify the formats of the real-time data and the memory-stored data. Therefore, the format of data temporarily stored in the buffer area of the MPU for the memory storage and the format of the real-time data are aligned.

It is also necessary to devise the way to store data in the memory. In the present invention, memory accesses are performed at regular intervals, and a certain amount of data temporarily stored in the buffer area of the MPU is collectively stored in the memory as described above. However, if a certain amount of data is stored in the memory without a rule, arrangement of the primary data and the secondary data varies when the memory-stored data is read and combined, and thus processing of sorting data becomes difficult. This causes a problem when the number of pieces of data is counted or timestamping is performed.

Therefore, in the present invention, not only an amount of data at the time of writing to the memory but also arrangement of data and a configuration ratio of the primary data and the secondary data are also unified. With this configuration, data is always stored in the memory in a certain unit and configuration at the time of memory access, and thus the number of memory accesses and the time thereof can be linked to the amount of stored data and the timestamp. An arrangement rule of the memory-stored data is constant, and thus, when the memory-stored data is read and combined, the data can be easily sorted according to the data type.

In order to make the arrangement rule of the memory-stored data constant, the data is stored in a specific order when the data is temporarily stored in the buffer area of the MPU. When the real-time transmission is switched to the memory storage, data is not stored in the memory in order from head data that is temporarily stored in the buffer area, but is stored in the memory in order from head data of a predetermined data unit. When the real-time transmission is switched to the memory storage, an incomplete data group less than a storage data unit is not stored but is discarded.

It is also necessary to consider timestamping the data stored in the memory. Unlike the real-time transmission, there is a difference in time between data storage and data reading due to the property of the memory storage, and thus it is impossible to identify an acquisition time from the data itself. Therefore, it is necessary to separately record time information in a header or the like of the memory-stored data. For timestamping, clock information of a real-time clock is used, and the number of pieces of data or the number of data units to be stored is stored in the memory together with the data.

Because the unit and configuration of data to be stored in the memory are determined as described above, only information regarding the start time and end time of the memory storage and minimum information such as the number of pieces of stored data or the number of stored data units are necessary when the data is timestamped. It is possible to timestamp the data at equal data acquisition intervals. Note that, for the purpose of completing data for each recording block that is a group of memory areas, the start time and end time of storage in each recording block and the number of pieces of data in the recording block may be recorded in the header or the like of the data.

By defining the unit and configuration of data to be stored in the memory as described above, it is possible to efficiently combine data files and stamp time information. It is also possible to smoothly perform processing at the time of switching between the memory storage and the real-time transmission. If a system design is insufficient, the real-time data and the memory-stored data may be duplicated or lost when the memory storage is switched to the real-time transmission.

Therefore, the present invention is designed to prioritize completion of the memory storage and wait for switching until storage in a predetermined data unit is completed, instead of switching to the real-time transmission immediately after a wireless communication session is established. The data unit is normally an amount of data for about one to two seconds. Therefore, even if switching from the memory storage to the real-time transmission is delayed, actual inconvenience does not occur. Until the storage in the data unit is completed, the MPU and the wireless communication unit of the sensor device perform transmission preparation and transmission standby such that the real-time transmission can be performed on data immediately after the stored data unit. In this manner, it is possible to appropriately switch operation without data duplication or loss. It is also possible to maintain the design in which data is stored in a certain unit and configuration, and thus an incomplete amount of data less than the storage unit is not stored when the memory storage ends.

From the viewpoint of using the real-time data and the memory-stored data in combination, a difference in time between the real-time data and the memory-stored data is a problem. If there is a difference in time, when pieces of data are combined, times of the pieces of data overlap, or time is interrupted (interval is increased) although the pieces of data are continuous. This makes it necessary to match the time of the real-time data with the time of the memory-stored data. The real-time data is timestamped on the basis of a real-time clock of the receiver, whereas the memory-stored data is timestamped on the basis of a real-time clock of the sensor device. Therefore, it is necessary to perform an operation for matching the real-time clock of the receiver with the real-time clock of the sensor device.

The present invention gives a top priority to combining the memory-stored data with the immediately preceding real-time data in consideration of storing data in the memory of the sensor device in order to complement the real-time data when the real-time transmission is interrupted. Therefore, the operation is designed so as not to cause a difference in time between the memory-stored data and the immediately preceding real-time data.

Specifically, real-time data to be transmitted from the sensor device immediately after a wireless communication session starts is used as a trigger to transmit a real-time clock synchronization command from the receiver to the sensor device, thereby synchronizing the real-time clock of the receiver with the real-time clock of the sensor device. The data is not stored in the memory during the real-time transmission. Therefore, even if the real-time clock of the sensor device is updated during the real-time transmission, the time does not greatly change during the memory storage.

According to the present invention, because the real-time clock of the sensor device is synchronized with the real-time clock of the receiver that receives the real-time data, the time of the memory-stored data stored after communication is disconnected matches with the time of the real-time data. Thus, no problem occurs when the memory-stored data and the real-time data are combined. As described above, preparation for the memory-stored data after the communication is disconnected is made immediately after the real-time data is created. This makes it possible to perform smooth data combination.

When the memory-stored data of the sensor device is read by another receiver different from the receiver that has first received the real-time data, in a case where clocks of the two receivers are different from each other, the time of the read memory-stored data does not match with the time of the real-time data to be received next, and the time of the first real-time data matches with the time of the memory-stored data. Note that, when a wireless communication session between the receiver that has read the memory-stored data and the sensor device is established, and the real-time transmission from the sensor device is started, the real-time clock of the sensor device is updated. Therefore, the time of the real-time data received by another receiver matches with the time of data to be stored in the memory when the wireless communication session is lost next.

The real-time clock is normally managed only by seconds. Time of less than one second is normally truncated. Therefore, for example, even if the real-time clock of the receiver is X (hour): Y (minute): Z (second) 0.999, the clock of the sensor device is X (hour): Y (minute): Z (second) at the time of time synchronization. Thus, a difference in time of slightly less than one second at the maximum occurs. The difference in time of one second may cause a problem in devices that handle continuous waveform data such as an electrocardiogram waveform, a myoelectric waveform, and an electroencephalogram waveform.

Therefore, in the present invention, when the real-time clocks are synchronized, time information of a millisecond or less is also transmitted to the sensor device together with information of the real-time clock of the receiver. The time information of a millisecond or less is stored in the sensor device, and, when the sensor data is stored in the memory, the time information of a millisecond or less is recorded in the header of the data. The time information of a second or more and the time information of a millisecond or less are separately stored, but, by using those pieces of time information in combination, it is possible to perform synchronization accurate to a millisecond or less. Thus, a problem hardly occurs even in sensor devices that handle waveform data.

### First Embodiment

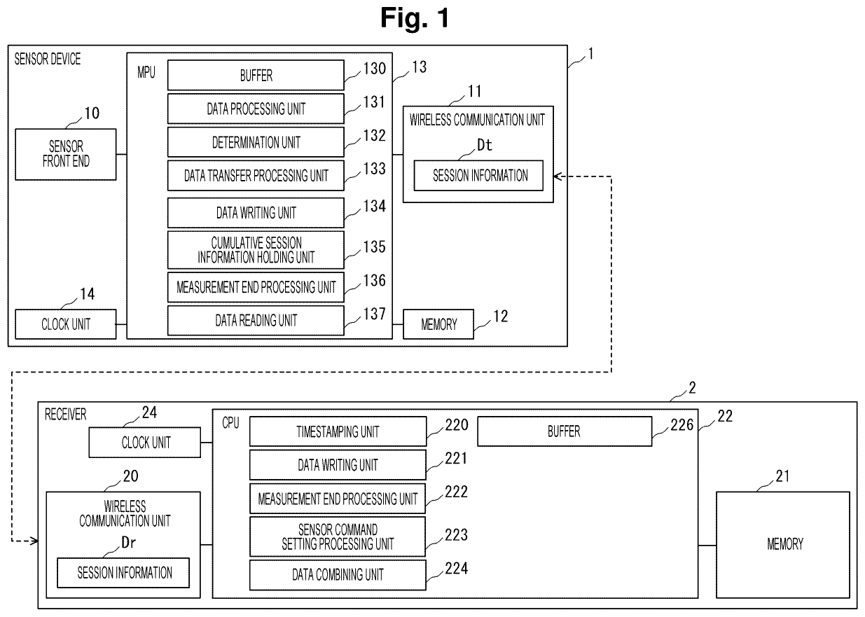

Hereinafter, a sensor device according to an embodiment of the present invention will be described with a specific example. FIG. 1 is a block diagram showing a configuration of a sensor data collection system according to a first embodiment of the present invention. The sensor data collection system includes a sensor device 1 that wirelessly transmits sensor data indicating a measured physical quantity and a receiver 2 that receives the sensor data.

The sensor device 1 includes a sensor front end 10 that outputs the sensor data including information regarding the measured physical quantity, a wireless communication unit 11 for communication with the receiver 2, a memory 12 for storing data, a micro processing unit (MPU) 13 that controls the entire sensor device, and a clock unit 14.

The MPU 13 performs processing in accordance with a program held therein and functions as a data processing unit 131, a determination unit 132, a data transfer processing unit 133, a data writing unit 134, a cumulative session information holding unit 135, a measurement end processing unit 136, and a data reading unit 137. The program to be processed can also be stored in the memory 12 or the like.

The receiver 2 includes a wireless communication unit 20 for communication with the sensor device 1, a memory 21 for storing data and a program, a central processing unit (CPU) 22 that controls the entire receiver, and a clock unit 24.

The CPU 22 performs processing in accordance with a program stored in the memory 21 and functions as a timestamping unit 220, a data writing unit 221, a measurement end processing unit 222, a sensor command setting processing unit 223, and a data combining unit 224. The processing program can also be stored in a location different from the memory 21.

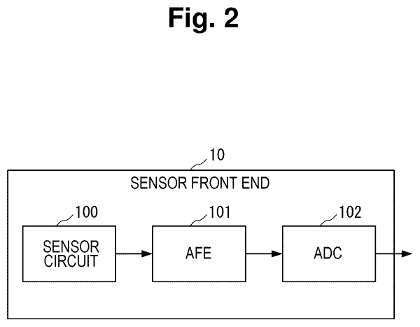

FIG. 2 is a block diagram showing a configuration example of the sensor front end 10 of the sensor device 1. The sensor front end 10 includes, for example, a sensor circuit 100 that measures a physical quantity such as an acceleration, an angular acceleration, and an electrocardiogram waveform, an analog front end circuit (AFE) 101 that performs processing such as amplification of an analog signal output from the sensor circuit 100 and noise removal, and an analog to digital (AD) converter (ADC) 102 that converts the analog signal output from the AFE 101 into digital data and outputs the digital data. The AFE 101 may include the ADC.

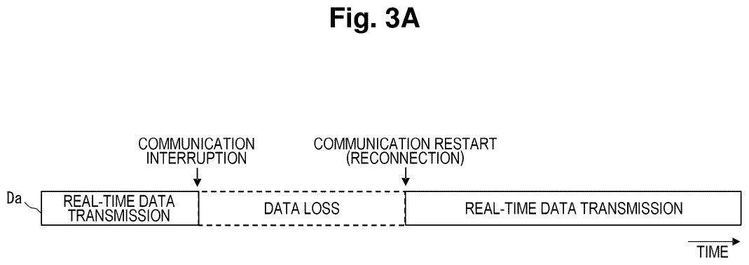

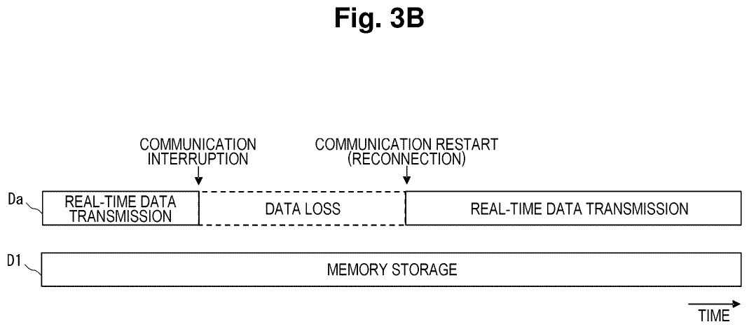

In conventionally known operation, the sensor device 1 wirelessly transmits sensor data D1 output from the sensor front end 10 to the receiver 2 in real time. In a case where the sensor device 1 includes no memory, as shown in FIG. 3A, real-time data Da (sensor data D1) cannot be transmitted when communication with the receiver 2 is interrupted, and a loss occurs in the data Da.

Meanwhile, in a case where the sensor device 1 includes a memory, as shown in FIG. 3B, the sensor data D1 is stored in the memory independently of the real-time data Da transmitted to the receiver 2. Considering long-term acquisition and utilization of a data set, the operations in FIGS. 3A and 3B are not desirable.

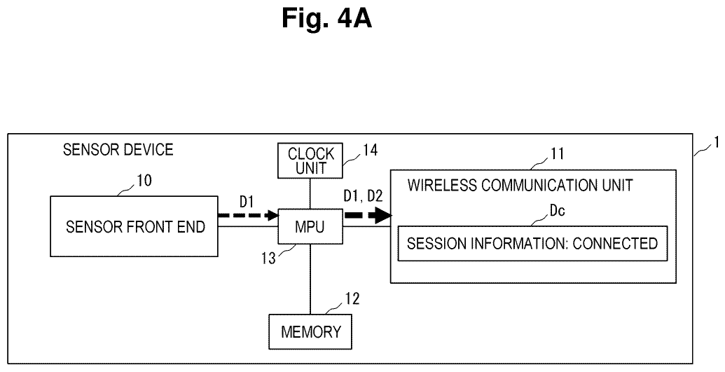

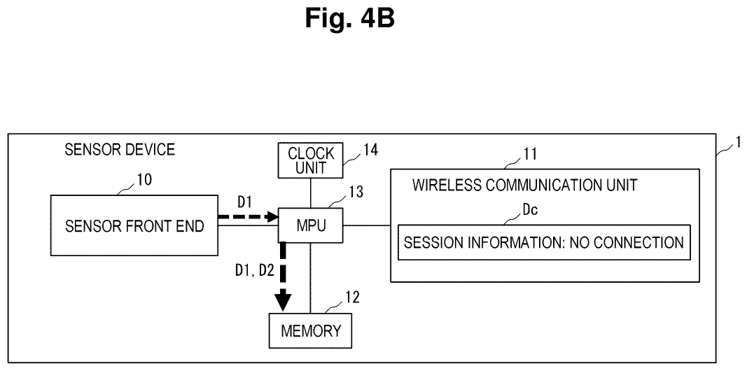

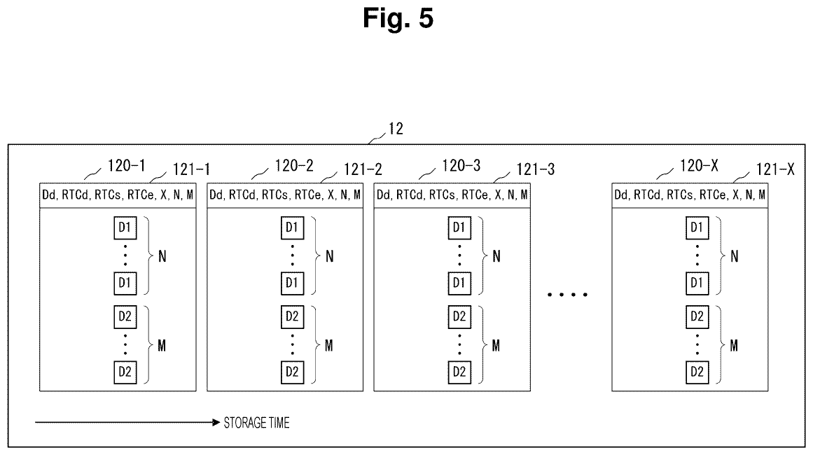

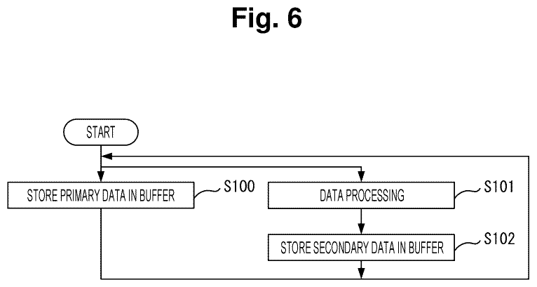

FIGS. 4A and 4B show operations of the sensor device 1, FIG. 5 shows a method of storing data in the memory 12 of the sensor device 1, and FIGS. 6 to 8 are flowcharts showing operations of the sensor device 1.

The sensor data D1 (primary data) output from the sensor front end 10 is temporarily stored in a buffer 130 of the MPU 13 (step S100 in FIG. 6). In the present embodiment, the number of pieces of primary data stored in the buffer 130 is N (N is an integer of 2 or more).

The data processing unit 131 of the sensor device 1 outputs secondary data D2 obtained by performing predetermined processing on the primary data D1 output from the sensor front end 10 (step S101 in FIG. 6). When the primary data D1 is electrocardiogram waveform data of a living body, the secondary data D2 is, for example, the RR interval (RRI) that is a time interval between the R wave and the previous R wave or a heart rate. When the primary data D1 is acceleration data of a living body, the secondary data D2 is, for example, an amount of activity of the living body. The data processing unit 131 can also output data by making the format of the secondary data D2 the same as the format of the primary data D1 output from the sensor front end 10.

As with the primary data, the secondary data output from the data processing unit 131 is temporarily stored in the buffer 130 (step S102 in FIG. 6). In the present embodiment, the number of pieces of secondary data stored in the buffer 130 is M (M is an integer of 1 or more). That is, M pieces of the secondary data are generated per N pieces of the primary data.

In the sensor device 1, the processing in steps S100 to S102 is constantly performed.

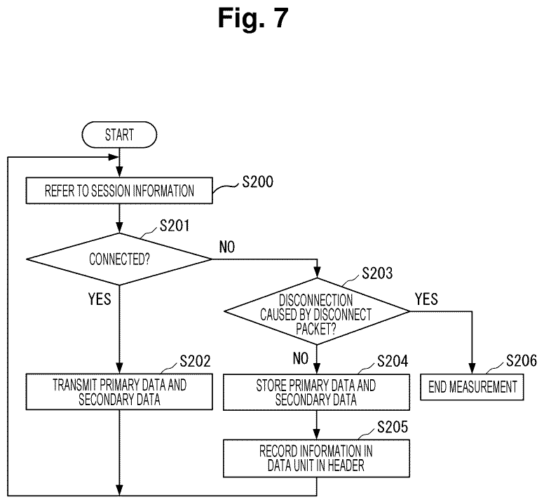

The determination unit 132 of the sensor device 1 refers to session information Dt managed by the wireless communication unit 11 (step S200 in FIG. 7) to determine whether or not the sensor device 1 is connected to the receiver 2 (step S201 in FIG. 7).

When the determination unit 132 determines that the sensor device is connected to the receiver 2 (YES in step S201), the data transfer processing unit 133 of the sensor device 1 stores the primary data D1 and the secondary data D2 in a packet and passes the packet to the wireless communication unit 11 (FIG. 4A). The wireless communication unit 11 wirelessly transmits the packet received from the data transfer processing unit 133 to the connected receiver 2 (step S202 of FIG. 7). In the present invention, the real-time data refers to the primary data D1 output from the sensor front end 10 and transmitted to the receiver 2 in real time and the secondary data D2 output from the data processing unit 131 and transmitted to the receiver 2 in real time.

For example, in the wireless communication standards such as BLE, the receiver 2 serving as a master device periodically transmits an empty packet even in a case where there is no content to be transmitted. The wireless communication unit 11 of the sensor device 1 serving as a slave device performs communication disconnect processing when the wireless communication unit 11 cannot receive a packet from the connected receiver 2 for a certain period of time (supervision time) or longer. In this case, the session information Dt is changed to a value indicating no connection.

When the user of the sensor data collection system intentionally ends communication (measurement), a disconnect packet is transmitted to the sensor device 1 by disconnect processing in the receiver 2. When receiving the disconnect packet from the receiver 2, the wireless communication unit 11 performs the communication disconnect processing.

When the determination unit 132 determines that the communication with the receiver 2 is disconnected (NO in step S201) and when the determination unit 132 determines that the disconnection is not caused by reception of a disconnect packet from the receiver 2 (NO in step S203 of FIG. 7), the data writing unit 134 of the sensor device 1 stores the primary data D1 and the secondary data D2 temporarily stored in the buffer 130 in the memory 12 (step S204 of FIG. 7, FIG. 4B).

The data writing unit 134 stores the primary data D1 and the secondary data D2 in one or a plurality of data units in each recording block of the memory 12 such that pieces of data are integrated into one group for each recording block. In the example of FIG. 5, the number of data units is X (X is an integer of 1 or more). In a case of the primary data D1, the number of pieces of data in each of the data units 120-1 to 120-X is N. In a case of the secondary data D2, the number of pieces of data in each of the data units 120-1 to 120-X is M.

The present embodiment is designed to temporarily store the same data content as the real-time data in the buffer 130 in consideration of using the real-time data and the memory-stored data in combination. An amount of temporarily stored data depends on how much data is collectively processed and how much data margin is provided when the operation of the sensor device 1 is switched, but only needs to be, for example, data of one or two seconds. In the present embodiment, data is stored in the memory 12 in the same format as the real-time data, but, as shown in FIG. 5, a certain amount of data is stored in the memory 12 together with a certain format in consideration of processing such as reading and combining the data later or sorting the data. This makes it extremely easy to perform data processing and timestamping.

The sensor device 1 includes a high-precision clock unit 14 called a real-time clock and can acquire time information from the clock unit 14. The cumulative session information holding unit 135 of the sensor device 1 can count the number of times of connection with the receiver 2 from the first connection and holds cumulative session information indicating the number of times of connection. For example, when the communication is interrupted due to deterioration of a radio wave condition or the like and then the connection is reestablished, the number of times of connection is incremented by one.

The cumulative session information indicates after which real-time data the data stored in the memory 12 has been stored. When the cumulative session information is recorded in, for example, the header of the data, it is possible to identify after which real-time data the data stored in the memory 12 has been stored and when the storage of the data has been started.

When the determination unit 132 determines that the communication with the receiver 2 is disconnected and when the determination unit 132 determines that the disconnection is not caused by reception of a disconnect packet from the receiver 2, the data writing unit 134 acquires time information RTCd from the clock unit 14 and acquires cumulative session information Dd from the cumulative session information holding unit 135. The acquired time information RTCd indicates the time when the session information has been canceled (the time when the communication with the receiver 2 has been disconnected). The acquired cumulative session information Dd indicates the number of times of connection with the receiver 2 until immediately before the communication with the receiver 2 is disconnected.

M pieces of the secondary data D2 are generated per N pieces of the primary data D1, and the primary data D1 and the secondary data D2 are stored in the memory 12 in parallel, and thus N pieces of the primary data D1 and M pieces of the secondary data D2 belonging to one data unit are finished to be stored in the memory 12 at the same time. The data writing unit 134 acquires the time information RTCs from the clock unit 14 when the primary data D1 and the secondary data D2 of the head data unit 120-1 among the X data units 120-1 to 120-X belonging to the same recording block are finished to be stored in the memory 12. The data writing unit 134 also acquires time information RTCe from the clock unit 14 when the primary data D1 and the secondary data D2 of the tail data unit 120-X among the X data units 120-1 to 120-X are finished to be stored in the memory 12.

Then, the data writing unit 134 records the cumulative session information Dd, the communication disconnection time information RTCd, the storage end time information RTCs of the head data unit, the storage end time information RTCe of the tail data unit, the number of data units X of one block, the number of pieces N of the primary data D1 belonging to one data unit, and the number of pieces M of the secondary data D2 belonging to one data unit in headers 121-1 to 121-X of the respective data units 120-1 to 120-X stored in the memory 12 (step S205 of FIG. 7).

Note that the header may be held for each data unit, or one header may be held for the entire data (120-1 to 120-X). Information of the header can be shared by a data group of the same cumulative session information.

When the determination unit 132 determines that the communication with the receiver 2 is disconnected (NO in step S201) and the determination unit 132 determines that the disconnection is caused by reception of a disconnect packet from the receiver 2 (YES in step S203), the measurement end processing unit 136 of the sensor device 1 brings the sensor device 1 into a measurement operation end state (step S206 of FIG. 7). In the measurement operation end state, data transmission to the receiver 2 and data storage in the memory 12 are not performed, but a packet can be received from the receiver 2.

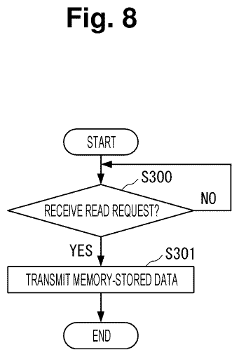

The data stored in the memory 12 of the sensor device 1 can be read after the storage ends. When the wireless communication unit 11 receives a read request command from the receiver 2 (YES in step S300 of FIG. 8), the data reading unit 137 of the sensor device 1 reads the primary data D1 and the secondary data D2 stored in the memory 12, stores the data in a packet, and passes the packet to the wireless communication unit 11. The wireless communication unit 11 wirelessly transmits the packet received from the data reading unit 137 to the connected receiver 2 (step S301 of FIG. 8).

As described later, the memory-stored data may be transmitted simultaneously with the real-time data.

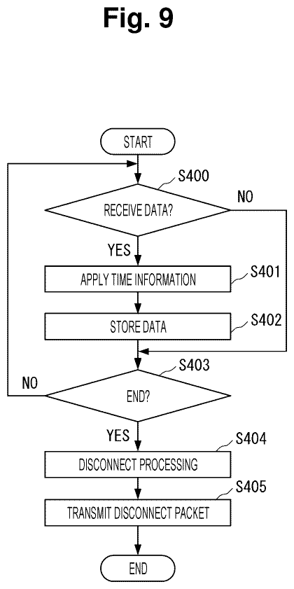

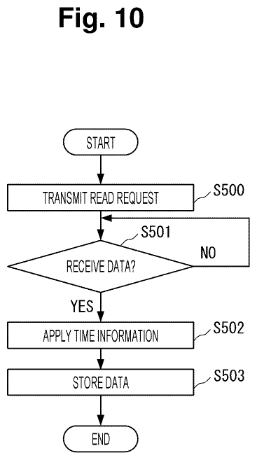

FIGS. 9 and 10 are flowcharts showing operations of the receiver 2. When receiving a packet transmitted from the sensor device 1 in real time (YES in step S400 of FIG. 9), the wireless communication unit 20 of the receiver 2 passes the received packet to the timestamping unit 220. The timestamping unit 220 extracts data (at least one of the primary data D1 and the secondary data D2) from the received packet. The timestamping unit 220 acquires time information from the clock unit 24 and applies the time information to the data extracted from the packet (step S401 of FIG. 9). Specifically, the timestamping unit 220 stores the time information in the header of the data, for example. The data writing unit 221 stores the data to which the time information has been applied in the memory 21 (step S402 of FIG. 9).

Although not explicitly shown in FIG. 9, the wireless communication unit 20 of the receiver 2 serving as a master device periodically transmits an empty packet to the connected sensor device 1 even in a case where there is no content to be transmitted. Meanwhile, the sensor device 1 serving as a slave device returns a response packet. The wireless communication unit 20 of the receiver 2 performs the communication disconnect processing when the wireless communication unit 20 cannot receive a packet from the connected sensor device 1 for a certain period of time (supervision time) or longer. In this case, session information Dr is changed to a value indicating no connection.

When ending the measurement operation (YES in step S403 of FIG. 9), the measurement end processing unit 222 of the receiver 2 requests the wireless communication unit 20 to perform the communication disconnect processing. The wireless communication unit 20 performs the communication disconnect processing (step S404 of FIG. 9) and transmits a disconnect packet to the sensor device 1 (step S405 of FIG. 9).

When the sensor device 1 reads the memory-stored data, the sensor command setting processing unit 223 of the receiver 2 requests the wireless communication unit 20 to transmit a read request command. The wireless communication unit 20 transmits a read request command to the sensor device 1 (step S500 in FIG. 10).

When receiving a packet transmitted from the sensor device 1 in response to the read request command (YES in step S501 of FIG. 10), the wireless communication unit 20 passes the received packet to the timestamping unit 220.

The timestamping unit 220 extracts data from the received packet, temporarily stores the data in the buffer 226, and applies time information to the data (step S502 of FIG. 10). Specifically, the timestamping unit 220 refers to the header of each data unit (120-1 to 120-X in FIG. 5) stored in the buffer 226 and acquires the cumulative session information Dd, the communication disconnection time information RTCd, the storage end time information RTCs of the head data unit, the storage end time information RTCe of the tail data unit, the number of data units X of one block, the number of pieces N of the primary data D1 belonging to one data unit, and the number of pieces M of the secondary data D2 belonging to one data unit.

In a case where the number of data units X is 1, the timestamping unit 220 sets a stamping interval I1 of the primary data D1 to a predetermined fixed value. In a case where the number of data units X is 2 or more, the timestamping unit 220 calculates the stamping interval I1 of the primary data D1 from the following equation on the basis of the time information RTCs and RTCe, the number of data units X, and the number of pieces N of the primary data D1 belonging to one data unit.

$$I 1 = ( RTCe - RTCs ) / \{ N \times ( X - 1 ) \} \qquad ( 1 )$$

The timestamping unit 220 calculates a time Ts1 when the head primary data D1 belonging to the X data units 120-1 to 120-X has been output from the sensor front end 10 of the sensor device 1 from the following equation on the basis of the time information RTCs, the number of pieces N of the primary data D1, and the stamping interval I1.

$$T s1 = RTCs - \{ ( N - 1 ) \times I 1 \} \qquad ( 2 )$$

In a case where the number of data units X is 1, the timestamping unit 220 sets a stamping interval I2 of the secondary data D2 to a predetermined fixed value. In a case where the number of data units X is 2 or more, the timestamping unit 220 calculates the stamping interval I2 of the secondary data D2 from the following equation on the basis of the time information RTCs and RTCe, the number of data units X, and the number of pieces M of the secondary data D2 belonging to one data unit.

$$I 2 = ( RTCe - RTCs ) / \{ M \times ( X - 1 ) \} \qquad ( 3 )$$

The timestamping unit 220 calculates a time Ts2 when the head secondary data D2 belonging to the X data units 120-1 to 120-X has been output from the data processing unit 131 of the sensor device 1 from the following equation on the basis of the time information RTCs, the number of pieces M of the secondary data D2, and the stamping interval I2.

$$Ts 2 = RTCs - \{ ( M - 1 ) \times I 2 \} \qquad ( 4 )$$

Then, the timestamping unit 220 applies information of the head data time Ts1 calculated from Equation (2) to the head primary data D1 belonging to the X data units 120-1 to 120-X. Specifically, the timestamping unit 220 stores the time information in the header of the primary data D1, for example. The timestamping unit 220 applies, to the second primary data D1 belonging to the X data units 120-1 to 120-X, time information obtained by cumulatively adding the stamping intervals I1 corresponding to the number of pieces of data to the head data time Ts1. Thereafter, similarly, the time information only needs to be applied to the primary data D1 while being sequentially updated by cumulatively adding the stamping intervals I1. The time of the tail primary data D1 belonging to the X data units 120-1 to 120-X is Ts1+I1×{(N×X)−1}. In this way, the time information can be applied to each of N× X pieces of the primary data D1 belonging to the X data units 120-1 to 120-X.

Similarly, the timestamping unit 220 applies information of the head data time Ts2 calculated from Equation (4) to the head secondary data D2 belonging to the X data units 120-1 to 120-X. The timestamping unit 220 applies, to the second secondary data D2 belonging to the X data units 120-1 to 120-X, time information obtained by cumulatively adding the stamping intervals I2 corresponding to the number of pieces of data to the head data time Ts2. Thereafter, similarly, the time information only needs to be applied to the secondary data D2 while being sequentially updated by cumulatively adding the stamping intervals I2. The time of the tail secondary data D2 belonging to the X data units 120-1 to 120-X is Ts2+I2×{(M×X)−1}. In this way, time information can be applied to each of M×X pieces of the secondary data D2 belonging to the X data units 120-1 to 120-X.

The timestamping unit 220 passes the data to which the time information has been applied to the data writing unit 221. The data writing unit 221 stores the data received from the timestamping unit 220 in the memory 21 (step S503 of FIG. 10).

In the present embodiment, data temporarily stored in the memory 12 of the sensor device 1 is read after a lapse of time after the storage, and thus accurate time information cannot be applied unless information for stamping is recorded in advance in the header or the like. The primary data D1 is acquired from the sensor front end 10 at substantially regular intervals, and fluctuation of acquisition intervals is sufficiently smaller than that of measurement intervals. Therefore, it is allowed to assume that the intervals of the primary data D1 are equal. Accordingly, it is possible to apply accurate time information to the memory-stored data in a case where there are the storage end time information RTCs of the head data unit, the storage end time information RTCe of the tail data unit, the number of data units X, the number of pieces N of the primary data D1 belonging to one data unit, and the number of pieces M of the secondary data D2 belonging to one data unit.

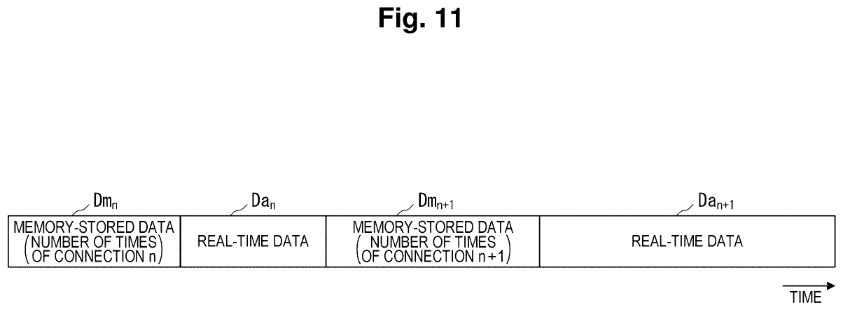

According to the present embodiment, data can be combined as shown in FIG. 11. However, the data combining unit 224 described below is not an essential component of the present invention and may be provided in a location other than the receiver 2.

The data combining unit 224 rearranges and combines the real-time data transmitted from the sensor device 1 in real time and stored in the memory 21 and the memory-stored data read after being temporarily stored in the memory 12 of the sensor device 1 and stored in the memory 21 in chronological order.

Specifically, the data combining unit 224 separates the memory-stored data temporarily stored in the memory 12 of the sensor device 1 among the pieces of data stored in the memory 21 on the basis of the cumulative session information Dd. For example, in a case where the number of times of connection indicated by the cumulative session information Dd is changed from n (n is a positive integer) to n+1, it means that a boundary between the memory-stored data in which the cumulative session information Dd indicates the number of times of connection n and the memory-stored data in which the cumulative session information Dd indicates the number of times of connection n+1 can be searched for. In this way, the memory-stored data can be separated by integrating the memory-stored data whose cumulative session information Dd indicates the same number of times of connection into one group.

Then, the data combining unit 224 connects the memory-stored data and the real-time data such that data at the latest time among the pieces of the memory-stored data whose cumulative session information Dd indicates the number of times of connection n is followed by the real-time data at the immediately following time. Further, the data combining unit 224 searches for real-time data at the latest time from among the pieces of real-time data at the time before data at the earliest time among the pieces of memory-stored data whose cumulative session information Dd indicates the number of times of connection n+1. Then, the data combining unit 224 connects the real-time data and the memory-stored data such that the searched real-time data is followed by the memory-stored data whose cumulative session information Dd indicates the number of times of connection n+1. It is only necessary to perform such data combination for the primary data D1 and the secondary data D2.

In the example of FIG. 11, a group of the memory-stored data whose cumulative session information Dd indicates the number of times of connection n is denoted by Dmₙ, and a group of the memory-stored data whose cumulative session information Dd indicates the number of times of connection n+1 is denoted by Dmₙ₊₁. A group of the real-time data whose head is connected to data at the latest time among pieces of the memory-stored data Dmₙ and whose tail is connected to data at the earliest time among pieces of the memory-stored data Dmₙ₊₁ is denoted by Daₙ. A group of the real-time data whose head is connected to data at the latest time among the pieces of the memory-stored data Dmₙ₊₁ is denoted by Daₙ₊₁.

As described above, in the present embodiment, it is possible to automatically switch between the real-time data transmission operation of the sensor device 1, the memory storage operation only for data that cannot be wirelessly transmitted, and the end of the measurement operation by condition determination based on the session information regarding the wireless communication state. The present embodiment can reduce the possibility that data loss occurs when data transmission becomes impossible due to, for example, deterioration of a radio wave condition. Further, because the real-time transmission and the data backup by the sensor device 1 are not performed in parallel, it is possible to reduce the possibility of data duplication. In the present embodiment, it is possible to apply accurate time information to data, thereby easily combining the real-time data and the memory-stored data. This makes it possible to improve the convenience of data utilization. The present embodiment does not need to store all sensor data in the memory 12 and thus does not require a large-capacity memory unlike the related art. This makes it possible to reduce the cost of the sensor device 1. Further, the present embodiment does not use the method by delivery confirmation in the related art, and thus a communication speed is not reduced due to the delivery confirmation.

### Second Embodiment

Next, a second embodiment of the present invention will be described. The present embodiment is an example where the first embodiment is devised such that data duplication or loss does not occur at the time of switching between the memory storage operation and the real-time transmission operation. Also in the present embodiment, the configuration of the sensor data collection system is similar to that of the first embodiment, and thus description will be made by using the reference signs in FIG. 1.

Although data duplication or loss can be reduced in the first embodiment, there is a possibility that data duplication or loss occurs when, after communication between the sensor device 1 and the receiver 2 is disconnected, a wireless communication session is established and the communication is restarted. Therefore, in the present embodiment, a switching timing from the memory storage operation to the real-time transmission operation of data is specified more precisely.

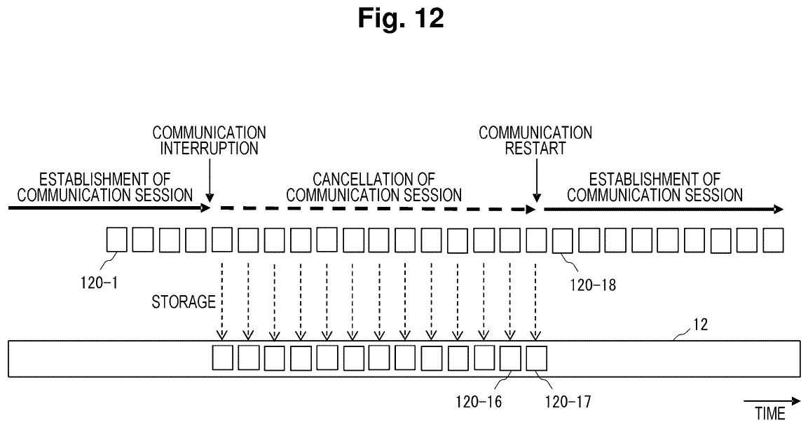

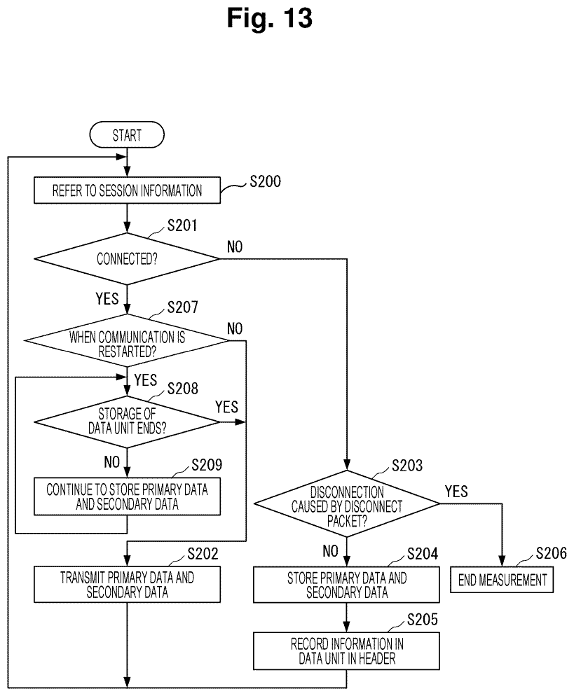

FIG. 12 shows an operation of the sensor device 1 of the present embodiment, and FIG. 13 is a flowchart showing the operation of the sensor device 1.

When, after data storage in the memory is started, a wireless communication session is established again and communication with the receiver 2 is restarted (YES in step S207 in FIG. 13), the data transfer processing unit 133 of the sensor device 1 does not switch to the real-time transmission immediately. The data transfer processing unit 133 and the wireless communication unit 11 perform transmission preparation and standby processing such that the real-time transmission can be performed on data immediately after data to be stored last in the memory.

When the communication with the receiver 2 is restarted (YES in step S207), if there is a data unit being written to the memory 12 (NO in step S208 of FIG. 13), the data writing unit 134 of the sensor device 1 continues to write the data unit (step S209 of FIG. 13).

When the communication with the receiver 2 is restarted and the writing of the data unit being written at the time of restart to the memory 12 ends (YES in step S208), the data transfer processing unit 133 stores the primary data D1 and the secondary data D2 immediately after the writing ends in a packet and passes the packet to the wireless communication unit 11. The wireless communication unit 11 wirelessly transmits the packet received from the data transfer processing unit 133 to the connected receiver 2 (step S202 of FIG. 13). Thus, the real-time transmission is restarted.

FIG. 12 shows an example where the communication between the sensor device 1 and the receiver 2 is restarted while data of a data unit 120-17 is being written to the memory 12 (is being prepared for writing or is during write processing). In this case, the writing of the data of the data unit 120-17 to the memory 12 is continued until the writing ends, and the real-time transmission is started from data of the next data unit 120-18.

A practical problem does not occur even if a time from establishment of the wireless communication session to actual switching to the real-time transmission is delayed by about one to two seconds. In the present embodiment, data duplication or loss does not occur at the time of switching between the memory storage operation and the real-time transmission operation, and switching can be smoothly performed.

### Third Embodiment

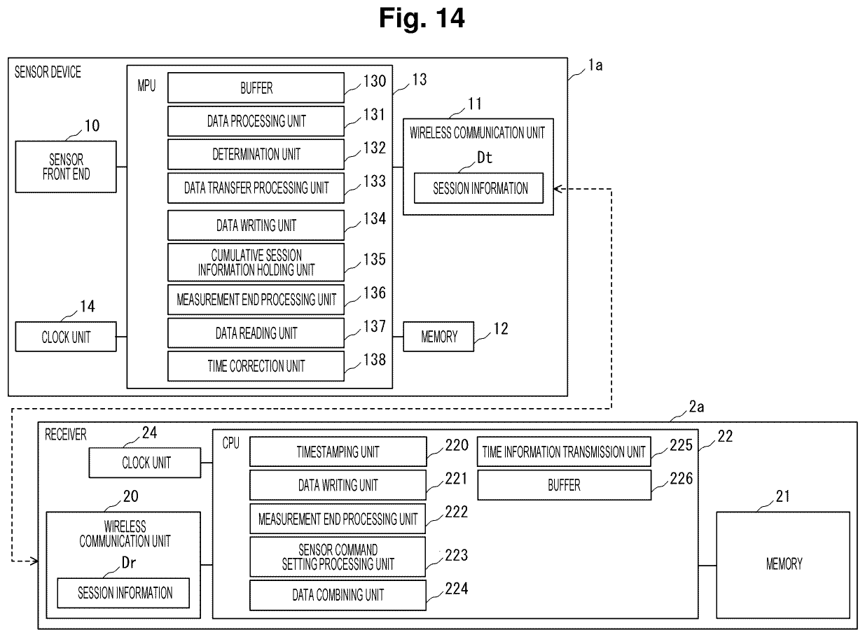

Next, a third embodiment of the present invention will be described. The present embodiment is an example of a sensor device that combines the real-time data and the memory-stored data to easily use the data as a data set. FIG. 14 is a block diagram showing a configuration of a sensor data collection system according to the present embodiment. The sensor data collection system of the present embodiment includes a sensor device 1a and a receiver 2a.

The sensor device 1a is obtained by adding a time correction unit 138 as a function implemented by the MPU 13.

The receiver 2a is obtained by adding a time information transmission unit 225 as a function implemented by the CPU 22.

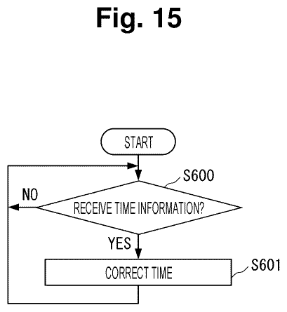

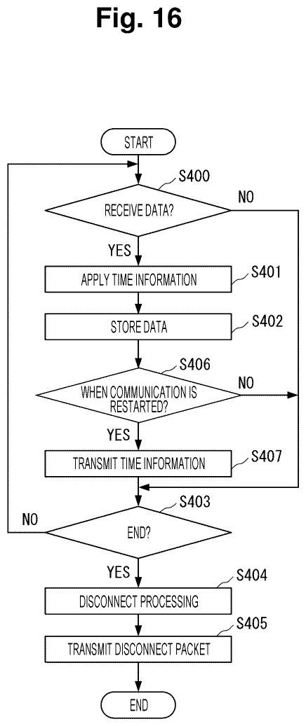

FIG. 15 is a flowchart showing an operation of the sensor device 1a, and FIG. 16 is a flowchart showing an operation of the receiver 2a.

When receiving a packet storing time information from the connected receiver 2a (YES in step S600 of FIG. 15), the data transfer processing unit 133 of the sensor device 1a extracts the time information from the received packet and passes the time information to the time correction unit 138. The time correction unit 138 corrects the time measured by the clock unit 14 on the basis of the time information received from the data transfer processing unit 133 (step S601 of FIG. 15). Other operations of the sensor device 1a are the same as those of the sensor device 1.

Next, the operation of the receiver 2a will be described. The processing in steps S400 to S402 and S403 to S405 of FIG. 16 is as described in the first embodiment.

When receiving data from the sensor device 1a, the time information transmission unit 225 of the receiver 2a refers to the session information Dr managed by the wireless communication unit 20 and, when determining that a timing is immediately after communication with the sensor device 1a is restarted (YES in step S406 of FIG. 16), the time information transmission unit acquires time information from the clock unit 24, stores the time information in a packet, and passes the packet to the wireless communication unit 20. The wireless communication unit 20 wirelessly transmits the packet received from the time information transmission unit 225 to the connected sensor device 1a (step S407 of FIG. 16). Alternatively, information indicating that time synchronization is necessary can be included in data first transmitted from the sensor device 1a after the communication is restarted.

The time information acquired from the clock unit 24 of the receiver 2a is applied to the real-time data. Meanwhile, the time information acquired from the clock unit 14 of the sensor device 1a is applied to the memory-stored data. Therefore, when there is a difference in time between the sensor device 1a and the receiver 2a, the real-time data and the memory-stored data are combined while the times thereof are different, and data duplication or loss occurs at some times.

The present embodiment prioritizes combining the memory-stored data with the real-time data and uses the first real-time data immediately after a wireless communication session is established as a trigger to transmit time information from the receiver 2a to the sensor device 1a, thereby performing time synchronization between the receiver 2a and the sensor device 1a.

Data is not stored in the memory 12 while the real-time data is being transmitted from the sensor device 1a, and thus, even if the time measured by the clock unit 14 is updated, a problem that the time greatly changes during data storage in the memory 12 does not occur. The present embodiment can synchronize the time between the sensor device 1a and the receiver 2a and can prevent a difference in time between the real-time data and the memory-stored data. Thus, no problem occurs in combining the real-time data and the memory-stored data. Note that the time synchronization is performed not only immediately after a wireless communication session is established, but also periodically at regular time intervals.

In the present embodiment, the sensor command setting processing unit 223 and the time information transmission unit 225 are described separately, but the sensor command setting processing unit 223 and the time information transmission unit 225 may be integrated into one.

Although the combination with the first embodiment has been described with reference to FIGS. 14 to 16, the present embodiment may be applied to the second embodiment.

### Fourth Embodiment

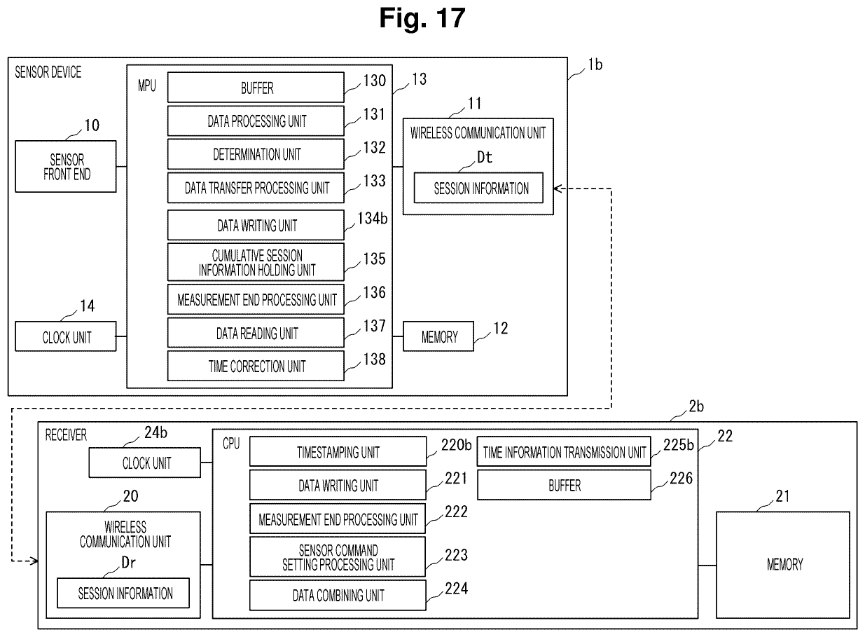

Next, a fourth embodiment of the present invention will be described. The present embodiment is an example of a sensor device that further suppresses a difference in time between the real-time data and the memory-stored data in the third embodiment. FIG. 17 is a block diagram showing a configuration of a sensor data collection system according to the present embodiment. The sensor data collection system of the present embodiment includes a sensor device 1b and a receiver 2b.

The sensor device 1b includes a sensor front end 10, a wireless communication unit 11, a memory 12, and an MPU 13.

The MPU 13 performs processing in accordance with a program stored in the memory 12 and functions as the data processing unit 131, the determination unit 132, the data transfer processing unit 133, a data writing unit 134b, the cumulative session information holding unit 135, the measurement end processing unit 136, the data reading unit 137, and the time correction unit 138.

The receiver 2b includes the wireless communication unit 20, the memory 21, the CPU 22, and a clock unit 24b.

The CPU 22 performs processing in accordance with a program and functions as a timestamping unit 220b, the data writing unit 221, the measurement end processing unit 222, the sensor command setting processing unit 223, the data combining unit 224, and a time information transmission unit 225b.

In the first to third embodiments, the real-time clock is used as the clock unit 24 of the receivers 2 and 2a, but in the present embodiment, a clock unit capable of measuring Coordinated Universal Time (UTC) is used as the clock unit 24b. The clock unit 24b can measure time by milliseconds or microseconds.

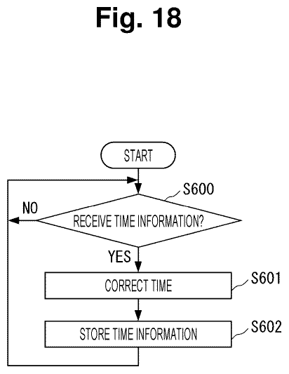

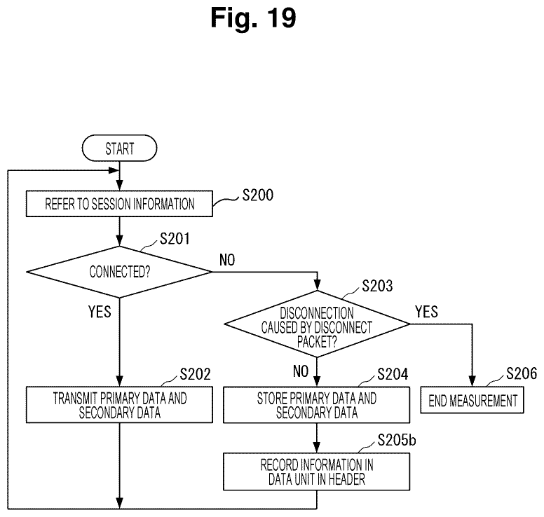

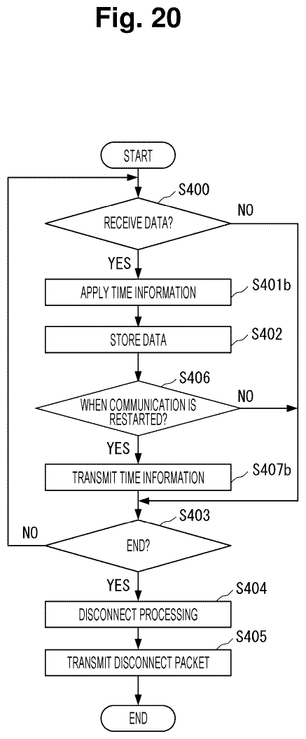

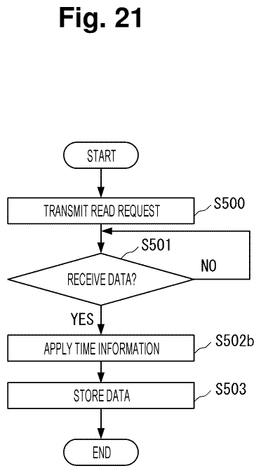

FIGS. 18 and 19 are flowcharts showing operations of the sensor device 1b, and FIGS. 20 and 21 are flowcharts showing operations of the receiver 2b.

The processing in steps S600 and S601 of FIG. 18 is as described in the third embodiment. Because the clock unit 14 (real-time clock) can measure the time only by seconds, time correction in step S601 is performed by seconds.

Meanwhile, when receiving a packet storing time information from the connected receiver 2b (YES in step S600 of FIG. 18), the data writing unit 134b of the sensor device 1b extracts time information of less than one second from the received packet and stores the time information in the memory 12 (step S602 of FIG. 18).

When recording the cumulative session information Dd, the communication disconnection time information RTCd, the storage end time information RTCs and RTCe, the number of data units X, the number of pieces N of the primary data D1, and the number of pieces M of the secondary data D2 in the header of each data unit stored in the memory 12, the data writing unit 134b records not only those pieces of information but also the time information of less than one second stored in step S602 in the header of each data unit (step S205b of FIG. 19). Other operations of the sensor device 1b are the same as those of the sensor device 1a.

Next, the operation of the receiver 2b will be described. The processing in steps S403 to S405 of FIG. 20 is as described in the first to third embodiments.

When receiving a packet transmitted from the sensor device 1b in real time (YES in step S400 of FIG. 20), the wireless communication unit 20 of the receiver 2b passes the received packet to the timestamping unit 220b. The timestamping unit 220b extracts data from the received packet. The timestamping unit 220b acquires time information from the clock unit 24b and applies the time information to the data extracted from the packet (step S401b of FIG. 20). The data writing unit 221 stores the data to which the time information has been applied in the memory 21 (step S402 of FIG. 20).

As described above, the clock unit 24b can measure the time of less than one second. Therefore, the time information applied to the real-time data by the timestamping unit 220b includes the time information of less than one second.

When receiving data from the sensor device 1b, the time information transmission unit 225b of the receiver 2b refers to the session information Dr managed by the wireless communication unit 20 and, when determining that a timing is immediately after communication with the sensor device 1b is restarted (YES in step S406 of FIG. 20), the time information transmission unit acquires time information from the clock unit 24b, stores the time information in a packet, and passes the packet to the wireless communication unit 20. The wireless communication unit 20 wirelessly transmits the packet received from the time information transmission unit 225b to the connected sensor device 1b (step S407b of FIG. 20). The time information transmitted from the time information transmission unit 225b to the sensor device 1b includes time information of less than one second.

Meanwhile, when applying time information to the memory-stored data read from the sensor device 1b and temporarily stored in the buffer 226, the timestamping unit 220b of the receiver 2b refers to the header of each data unit stored in the buffer 226. The timestamping unit 220b records the time information to be applied to the primary data D1 and the secondary data D2 of each data unit after shifting the time information by the time information of less than one second recorded in the header of each data unit (step S502b of FIG. 21). Specifically, the timestamping unit 220b only needs to add the time of less than one second to the head data time Ts1 calculated from Equation (2) and to the head data time Ts2 calculated from Equation (4). Other operations of the receiver 2b are the same as those of the receiver 2a.

The real-time clock normally has the second as the smallest unit, and thus the time of less than one second is truncated in the time synchronization of the third embodiment. Therefore, a difference in time of slightly less than one second at the maximum occurs between the sensor device 1a and the receiver 2a.

In the present embodiment, when time synchronization is performed between the receiver 2b and the sensor device 1b, the time information of less than one second is also transmitted to the sensor device 1b. The time information of less than one second is recorded in the header of the memory-stored data. When the memory-stored data is read from the sensor device 1b and the time information is applied, the time information to be applied to the memory-stored data can be shifted in units of less than one second on the basis of the time information of less than one second recorded in the header. The present embodiment can synchronize the time between the real-time data and the memory-stored data to the unit of less than one second, and thus a problem hardly occurs even in sensor devices that handle waveform data.

### Fifth Embodiment

Next, a fifth embodiment of the present invention will be described. The present embodiment is an example where sensor data is easily acquired as compared with the first to fourth embodiments. Also in the present embodiment, the configuration of the sensor data collection system is similar to that of the first embodiment, and thus description will be made by using the reference signs in FIG. 1.

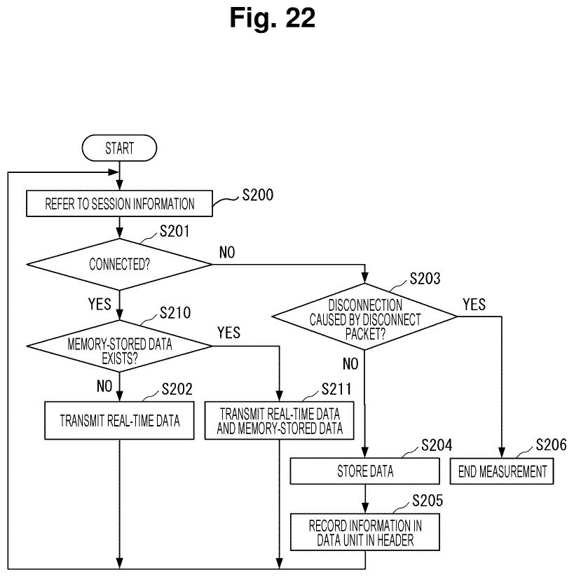

FIG. 22 is a flowchart showing an operation of the sensor device 1 of the present embodiment. The processing in steps S200 to S206 of FIG. 22 is as described in the first embodiment.

When the determination unit 132 determines that the sensor device is connected to the receiver 2 (YES in step S201 of FIG. 22) and the determination unit 132 also determines that untransmitted primary data D1 and secondary data D2 are stored in the memory 12 (YES in step S210 of FIG. 22), the data reading unit 137 of the sensor device 1 reads the primary data D1 and the secondary data D2 stored in the memory 12. The data transfer processing unit 133 stores the data read by the data reading unit 137 in a packet and passes the packet to the wireless communication unit 11. The wireless communication unit 11 wirelessly transmits the packet received from the data transfer processing unit 133 to the connected receiver 2.

When the sensor device is connected to the receiver 2 and untransmitted data is stored in the memory 12, a packet storing the real-time data is output to the wireless communication unit 11, and the packet storing the data read from the memory 12 is output to the wireless communication unit 11. The wireless communication unit 11 can simultaneously transmit the packet storing the real-time data and the packet storing the data read from the memory 12 by alternately transmitting the packets or transmitting the packets in accordance with a predetermined rule that does not cause a delay in transmission of the real-time data (step S211 of FIG. 22). Meanwhile, when the sensor device is connected to the receiver 2 and untransmitted data is not stored in the memory 12, only the packet storing the real-time data is transmitted to the receiver 2 as described above (step S202 of FIG. 22).

In a case where untransmitted data is stored in the memory 12, a transmission format is not limited to the above example in step S211, and any transmission format may be defined in advance.

As described above, the sensor device 1 of the present embodiment can read data from the memory 12 in parallel with the real-time data at an appropriate timing during measurement. In the present embodiment, a reading operation can be automatically completed without causing the user to be aware of reading data from the sensor device 1. This makes it possible to improve the convenience for the user. Further, in the present embodiment, a free space of the memory 12 can be automatically increased. This makes it possible to significantly extend a time during which a data loss prevention function can be maintained.

Although the combination with the first embodiment has been described with reference to FIG. 22, the present embodiment may be applied to the second to fourth embodiments.

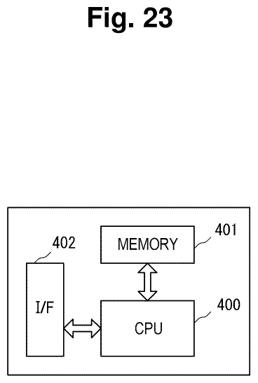

The timestamping units 220 and 220b, the data writing unit 221, the measurement end processing unit 222, the sensor command setting processing unit 223, the data combining unit 224, the time information transmission units 225 and 225b, and the wireless communication unit 20 of the receivers 2, 2a, and 2b described in the first to fifth embodiments can be implemented by a computer including a CPU, a memory, and an interface and a program for controlling those hardware resources. A configuration example of this computer is shown in FIG. 23.

The computer includes a CPU 400, a memory 401, and an interface device (I/F) 402. The I/F 402 is connected to hardware or the like of the clock units 24 and 24b and the wireless communication unit 20. The CPU 400 (CPU 22) of the receivers 2, 2a, and 2b performs the processing described in the first to fifth embodiments in accordance with a sensor data collection program stored in the memory 401 (memory 21).

The data processing unit 131, the determination unit 132, the data transfer processing unit 133, the data writing units 134 and 134b, the cumulative session information holding unit 135, the measurement end processing unit 136, the data reading unit 137, the time correction unit 138, and the wireless communication unit 11 of the sensor devices 1, 1a, and 1b can also be implemented by a computer. The I/F 402 of the sensor devices 1, 1a, and 1b is connected to hardware or the like of the sensor front end 10, the clock unit 14, and the wireless communication unit 11. The CPU 400 (MPU 13) of the sensor devices 1, 1a, and 1b performs the processing described in the first to fifth embodiments in accordance with the sensor data collection program stored in the memory 401 (memory 12).

In the computer described above, the sensor data collection program for implementing a sensor data collection method of the present invention is provided in a state of being recorded on a recording medium such as a flexible disk, a CD-ROM, a DVD-ROM, or a memory card. The program may also be provided via a network.

Some or all of the above embodiments can also be described as the following supplementary notes, but are not limited to the followings.

(Supplementary Note 1) A sensor data collection method of the present invention includes: a first step in which a sensor device refers to session information managed by a wireless communication unit of the sensor device to determine whether or not the sensor device is connected to a receiver; a second step in which, when determining that the sensor device is connected to the receiver, the sensor device stops storing data to be transmitted to the receiver in a memory of the sensor device and wirelessly transmits the data to the receiver; a third step in which, when determining that communication with the receiver is disconnected on the basis of the session information and also determining that the disconnection is not caused by reception of a disconnect packet from the receiver, the sensor device stores the data in the memory; and a fourth step in which the sensor device stores time information acquired from a clock unit of the sensor device in the memory in association with the data stored in the memory, in which the third step includes a step of receiving data of a same format as the data to be transmitted to the receiver from a buffer of the sensor device and storing the data in the memory in a specific order for each predetermined data unit.

(Supplementary Note 2) In the sensor data collection method according to supplementary note 1, the second step includes a step of, when the communication with the receiver is restarted after the communication is disconnected, restarting transmission of the data to the receiver immediately after storage of the data of the predetermined data unit in the memory ends, instead of immediately restarting transmission of the data to the receiver.

(Supplementary Note 3) The sensor data collection method according to supplementary note 1 further includes: a fifth step in which the sensor device receives time information transmitted from the receiver in response to the receiver receiving first data transmitted from the sensor device immediately after the communication is restarted; and a sixth step in which the sensor device corrects a time measured by the clock unit on the basis of the time information received from the receiver.

(Supplementary Note 4) The sensor data collection method according to supplementary note 3 further includes a seventh step in which the sensor device stores time information of less than one second transmitted from the receiver in the memory, in which the fourth step includes a step of storing the time information of less than one second in the memory in association with the data stored in the memory.

(Supplementary Note 5) A sensor device according to the present invention includes: a wireless communication unit configured to perform communication with a receiver; a memory for storing data to be transmitted to the receiver; a clock unit configured to measure time; and an MPU that, when determining that the sensor device is connected to the receiver on the basis of session information managed by the wireless communication unit, stops storing the data to be transmitted to the receiver in the memory and wirelessly transmits the data to the receiver via the wireless communication unit in real time, and, when determining that communication with the receiver is disconnected on the basis of the session information and also determining that the disconnection is not caused by reception of a disconnect packet from the receiver, stores the data in the memory and stores time information acquired from the clock unit in the memory in association with the data, in which the MPU receives data of a same format as the data to be transmitted to the receiver from a buffer and stores the data in the memory in a specific order for each predetermined data unit.

(Supplementary Note 6) In the sensor device according to supplementary note 5, when the communication with the receiver is restarted after the communication is disconnected, the MPU restarts transmission of the data to the receiver immediately after storage of the data of the predetermined data unit in the memory ends, instead of immediately restarting transmission of the data to the receiver.

(Supplementary Note 7) In the sensor device according to supplementary note 5, the MPU corrects a time measured by the clock unit on the basis of time information transmitted from the receiver in response to the receiver receiving first data transmitted from the sensor device immediately after the communication is restarted.

(Supplementary Note 8) In the sensor device according to supplementary note 7, the MPU stores time information of less than one second transmitted from the receiver in the memory and stores the time information of less than one second in the memory in association with the data stored in the memory.

### INDUSTRIAL APPLICABILITY

The present invention can be applied to a technology of collecting sensor data from a sensor device.

### REFERENCE SIGNS LIST

1, 1a, 1b Sensor device
2, 2a, 2b Receiver
10 Sensor front end
11, 20 Wireless communication unit
12, 21 Memory
13 MPU
14, 24, 24b Clock unit
22 CPU
100 Sensor circuit
101 Analog front end circuit
102 AD converter
130, 226 Buffer
131 Data processing unit
132 Determination unit
133 Data transfer processing unit
134, 221 Data writing unit
135 Cumulative session information holding unit
136, 222 Measurement end processing unit
137 Data reading unit
138 Time correction unit
220, 220b Timestamping unit
223 Sensor command setting processing unit
224 Data combining unit
225, 225b Time information transmission unit

1-8. (canceled)

9. A sensor data collection method for a sensor device including a wireless communication circuit, a memory, a clock circuit and a buffer, the method comprising:
determining whether or not the sensor device is connected to a receiver by referring to session information managed by the wireless communication circuit;
when it is determined that the sensor device is connected to the receiver, wirelessly transmitting data to the receiver without storing the data in the memory;
when it is determined that communication with the receiver is disconnected on the basis of the session information and that the disconnection is not caused by reception of a disconnect packet from the receiver, receiving data from the buffer in a format for transmitting to the receiver and storing the data in the memory in a specific order for each predetermined data unit; and
storing time information acquired from the clock circuit in the memory in association with the data stored in the memory.

10. The sensor data collection method according to claim 9, wherein
when wirelessly transmitting data to the receiver without storing the data in the memory, if the communication with the receiver is restarted after the communication was disconnected, storing the data of the predetermined data unit in the memory, and then restarting transmission of the data to the receiver.

11. The sensor data collection method according to claim 9, further comprising:
receiving time information transmitted from the receiver in response to the receiver receiving first data transmitted from the sensor device immediately after the communication is restarted; and
correcting a time measured by the clock circuit on the basis of the time information received from the receiver.

12. The sensor data collection method according to claim 11, further comprising
storing time information of less than one second transmitted from the receiver in the memory, wherein
when storing the time information acquired from the clock circuit in the memory in association with the data stored in the memory, storing the time information of less than one second in the memory in association with the data stored in the memory.

13. A sensor device comprising:
a wireless communication circuit configured to perform communication with a receiver;
a memory for storing data to be transmitted to the receiver;
a clock circuit configured to measure time; and
an MPU configured to:
determine whether or not the sensor device is connected to a receiver by referring to session information managed by the wireless communication circuit,
when determining that the sensor device is connected to the receiver on the basis of session information managed by the wireless communication circuit, wirelessly transmit data to the receiver via the wireless communication circuit in real time without storing the data to be transmitted to the receiver in the memory, and
when determining that communication with the receiver is disconnected on the basis of the session information and that the disconnection is not caused by reception of a disconnect packet from the receiver, receive data from a buffer in a format for transmitting to the receiver and store the data and time information acquired from the clock circuit in the memory in association with the data.

14. The sensor device according to claim 13, wherein
when wirelessly transmitting the data to the receiver without storing the data in the memory, if the communication with the receiver is restarted after the communication was disconnected, the MPU stores the data of the predetermined data unit in the memory, and then restarts transmission of the data to the receiver.

15. The sensor device according to claim 13, wherein
the MPU corrects a time measured by the clock circuit on the basis of time information transmitted from the receiver in response to the receiver receiving first data transmitted from the sensor device immediately after the communication is restarted.

16. The sensor device according to claim 15, wherein
when storing the time information acquired from the clock circuit in the memory in association with the data stored in the memory, the MPU further stores time information of less than one second transmitted from the receiver in the memory in association with the data stored in the memory.

17. A non-transitory computer-readable storage medium storing instructions that, when executed by a processor of a sensor device, cause the processor to perform operations comprising:
monitoring session information managed by a wireless communication circuit of the sensor device to determine a connection status with a receiver;
when the connection status indicates the sensor device is connected to the receiver, controlling the sensor device to wirelessly transmit sensor data to the receiver in real time without storing the sensor data in a memory of the sensor device;
when the connection status indicates communication with the receiver is disconnected and the disconnection is not caused by reception of a disconnect packet from the receiver, controlling the sensor device to store the sensor data in the memory in predetermined data blocks, each data block comprising a specific number of data elements arranged in a specific order; and
associating time information obtained from a clock circuit of the sensor device with the sensor data stored in the memory.

18. The non-transitory computer-readable storage medium according to claim 17, wherein the operations further comprise:
when the connection status changes from disconnected to connected, completing storage of a current data block in the memory before resuming real-time transmission of the sensor data to the receiver.

19. The non-transitory computer-readable storage medium according to claim 17, wherein the operations further comprise:
receiving synchronization time information from the receiver when communication is reestablished; and
updating a time maintained by the clock circuit based on the synchronization time information.

20. The non-transitory computer-readable storage medium according to claim 19, wherein the operations further comprise:
storing sub-second time information received from the receiver in the memory; and
associating the sub-second time information with the sensor data stored in the memory for enhanced time precision.

21. The non-transitory computer-readable storage medium according to claim 17, wherein the operations further comprise:
maintaining cumulative session information indicating a number of connection sessions with the receiver; and
storing the cumulative session information in association with the sensor data in the memory to enable identification of data storage sequences.

22. The non-transitory computer-readable storage medium according to claim 17, wherein the operations further comprise:
when the sensor device is connected to the receiver and untransmitted sensor data exists in the memory, simultaneously transmitting real-time sensor data and the untransmitted sensor data from the memory to the receiver.

23. The non-transitory computer-readable storage medium according to claim 17, wherein the sensor data comprises primary data obtained from a sensor front end and secondary data derived from processing the primary data, and wherein each predetermined data block comprises a specified number of primary data elements and a specified number of secondary data elements.

24. The non-transitory computer-readable storage medium according to claim 17, wherein the operations further comprise:
when the connection status indicates the disconnection is caused by reception of the disconnect packet from the receiver, terminating data collection operations and entering a measurement end state.
